(19) United States
(12) Patent Application Publication
(10) Pub. No.: US 2013/0039070 A1
(43) Pub. Date: Feb. 14, 2013

(54) LAMP WITH FRONT FACING HEAT SINK

(71) Applicant: Daniel J. Mathieu, Sheboygan Falls, WI (US)

(72) Inventor: Daniel J. Mathieu, Sheboygan Falls, WI (US)

(21) Appl. No.: 12/973,457

(22) Filed: Dec. 20, 2010

(51) Int. Cl. F21V 29/00

(52) U.S. Cl. 362/294

(57) ABSTRACT

An LED lamp has a front facing heat sink. The lamp has one or more LEDs paired with reflectors that direct the light produced by the LEDs out the front of the lamp. The lamp heat sink is configured to dissipate the excess heat generated by the LEDs toward the front of the lamp.

### FIELD OF THE INVENTION

The present invention relates generally to the field of light emitting diode (“LED”) lamps. More particularly, the present invention relates to an LED lamp with a heat sink thermally coupled and adjacent to the LEDs and positioned toward the front of the lamp.

### BACKGROUND

In the field of LED lamps, especially super bright and high power LEDs, there is a need to dissipate the heat generated by the LEDs themselves through the use of heat sinks LEDs are a commonly used light source in applications including lighting, signaling, signage, and displays. LEDs have many advantages over both incandescent and fluorescent lamps, including long service life, low power consumption, high reliability, fast response, small size, and resistance to vibration.

An LED is a semiconductor diode that emits light when an electrical current is applied to it. LEDs come in a variety of sizes, colors, and brightness. Light is a visual indication of the release of energy, and with any release of energy there is some heat generated. Both traditional incandescent light bulbs and LEDs convert the majority of the energy applied to the lamp in the form of heat. LEDs typically have a heat pad that is integrated into the LED itself that directs the heat generated by the LED through the base of the LED, away from the direction light is produced. The conversion of most of the energy applied to incandescent bulbs to heat is not a serious issue, however, because incandescent bulbs are constructed of materials designed to withstand the elevated temperature. LEDs, on the other hand, are susceptible to decreased efficiency or failure at elevated temperature. LED's also differ from incandescent lamps in that LEDs do not produce light by simply resisting electric current passing through a filament. Rather, LEDs are typically positioned on printed circuit boards (“PCBs”) and require more sophisticated electronics than incandescent lamps. LEDs like those necessary to generate light comparable to incandescent bulbs generate enough heat that the use of a heat sink is necessary in most environments for the lamp to operate reliably and efficiently. Further, lenses, reflectors, and other components are typically used to direct and focus the light generated by the LEDs and those components may also be temperature sensitive.

Traditional incandescent lamps come in many shapes and sizes, which are standardized throughout the lamp industry. One common type is the Parabolic Aluminized Reflector (“PAR”) lamp. PAR lamps are typically used for commercial, residential, and transportation illumination, such as vehicle headlamps, and residential and commercial recessed lights. PAR lamps are configured to direct nearly all of their light out of the front of the lamp. Depending on the parabolic reflector geometry and placement of the incandescent filament within the lamp, PAR lamps can achieve a wide range of beam widths, from narrow spot to wide flood. PAR lamps are typically higher power than traditional incandescent bulbs and have a typically 2500-4500 hour life span.

In order to accommodate the wide variety of shapes and sizes of incandescent lamps, LED replacement lamps with heat sinks incorporated into the support structure of the lamp itself must vary the shape and size of the heat sink structure for each lamp shape. This necessary variation is very costly due to the need for special tooling for each shape as well as the increased material cost associated with using metal instead of plastic. Also, this need to conform to a certain standard shape causes many existing LED lamps to use more metal than would otherwise be necessary to dissipate heat in their heat sink structures.

Another type of bulb that may be replaced by LED lamps are conventional fluorescent tubes. There are many disadvantages associated with conventional fluorescent tubes. Fluorescent tubes, while more energy efficient than incandescent bulbs, still consume more electricity than LED lamps. Fluorescent tubes also typically contain mercury, a highly poisonous metal that may be released if the tube shatters. Further, the color of light produced by fluorescent tubes is considered harsh and unpleasant by many viewers. Finally, the mercury atoms in fluorescent tubes must be ionized before an arc can be produced and light generated by the tube. In order for ionization of mercury to occur, it must be subjected to increased voltage. In some larger fluorescent tubes, the ionization will occur only after substantial voltage is applied to the tube. LED bulbs, on the other hand, do not require such increased voltage to start producing light, do not contain harmful mercury, and produce light that is more pleasing to consumers.

There are several existing LED lamps that incorporate heat sinks into various aspects of the lamp design. Many designs incorporate a heat sink into the support structure of the lamp itself. Heat sinks are typically constructed of heat conducting materials such as aluminum or some other metal, and are configured to maximize available surface area so heat may be efficiently transferred to the material, typically the air, surrounding the heat sink. The existing designs suffer from several performance and aesthetic deficiencies that are overcome by the designs disclosed herein.

### SUMMARY

The present invention relates to an LED lamp with a heat sink positioned toward the front of the lamp where ambient convention can most effectively cool it. The LED and heat sink arrangement is configured to sufficiently dissipate any excess heat generated by the LEDs, thus allowing, if desired, the remaining support structure of the lamp to be constructed of non-thermally conductive materials. The arrangement of the LEDs and heat sink also allow the front of the lamp to be a standard shape that can be used to create lamps of many shapes and sizes and with an aesthetically pleasing front face, thus reducing tooling costs necessary to produce multiple lamp shapes. The lamp includes at least one LED on a printed circuit board, thermally coupled to a heat sink, in a housing structure.

One embodiment of the present invention is a lamp having one or more LEDs arranged around the central axis of the lamp. Such an arrangement may be round, oval, square, or any other shape. The LEDs are positioned such that the heat pad of each LED is positioned to direct heat toward the front of the lamp. The LEDs are adapted to produce light that is reflected off of a corresponding series of reflectors toward the central axis of the lamp. Surrounding the LEDs, and thermally coupled thereto, is a heat sink that extends around the central axis. The heat sink is thermally coupled to the LEDs such that the heat generated by them is dissipated through the heat sink. The heat sink may any shape or size and may have a series of fins that are functional and/or decorative. The heat sink may be made of any thermally conductive material and may be any color. The lamp and heat sink assembly are non-thermally coupled to a base structure that need not be thermally conductive. A thermal insulator may be used between the heat sink and base structure. The base structure positions the LED and heat sink assembly from an electrical connector. Such an offset is used to match the form of existing incandescent bulbs whose shapes are determined by the necessary optics involved therein.

In another embodiment of the present invention, the LED and heat sink assembly may be configured to replace fluorescent tube lamps. In such an embodiment, rather than being configured in a ring, the LEDs are arranged longitudinally, with thermally conductive heat sink materials running lengthwise with the line of LEDs. The LED and heat sink are mounted together to emulate the a traditional fluorescent tube. Such an arrangement could be adapted to any shape, such as a circle, in-line, or otherwise positioned along the length, and the heat sink could be configured in a variety of ways without departing from the invention.

It should be noted that although LEDs are the preferred light source described herein, other light sources could be substituted for LEDs without departing from the invention.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of an LED lamp in accordance with the invention.

FIG. 2 is a front view of the LED lamp of FIG. 1.

FIG. 3 is a side view of the LED lamp of FIG. 1.

FIG. 4 is a section view of the LED lamp of FIG. 2, taken generally along the line 4-4 in FIG. 2.

FIG. 5 is an exploded perspective view of the LED lamp of FIG. 1

FIG. 5a is a partially exploded perspective view of an alternative embodiment of an LED lamp in accordance with the invention.

FIG. 6 is a perspective view of another embodiment of an LED lamp in accordance with the invention.

FIG. 7 is a front view of the LED lamp of FIG. 6.

FIG. 8 is a perspective view of another embodiment of an LED lamp in accordance with the invention.

FIG. 9 is a front view of the LED lamp of FIG. 8.

FIG. 10 is a perspective view of another embodiment of an LED lamp in accordance with the invention.

FIG. 11 is a side view of the LED lamp of FIG. 10.

FIG. 12 is a section view of the LED lamp of FIG. 11, taken generally along the line 12-12 in FIG. 11.

### DETAILED DESCRIPTION

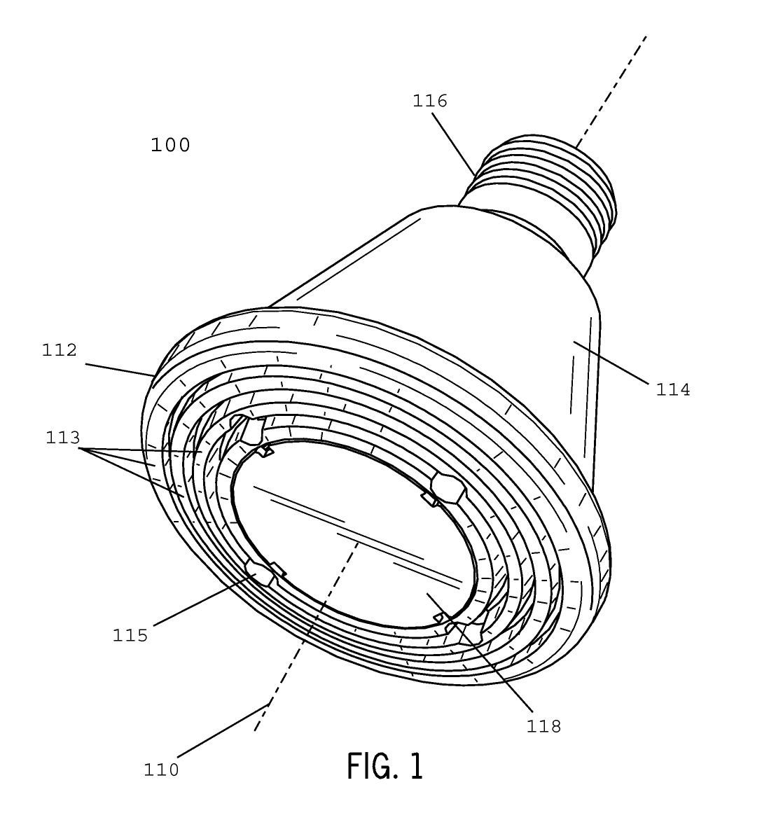

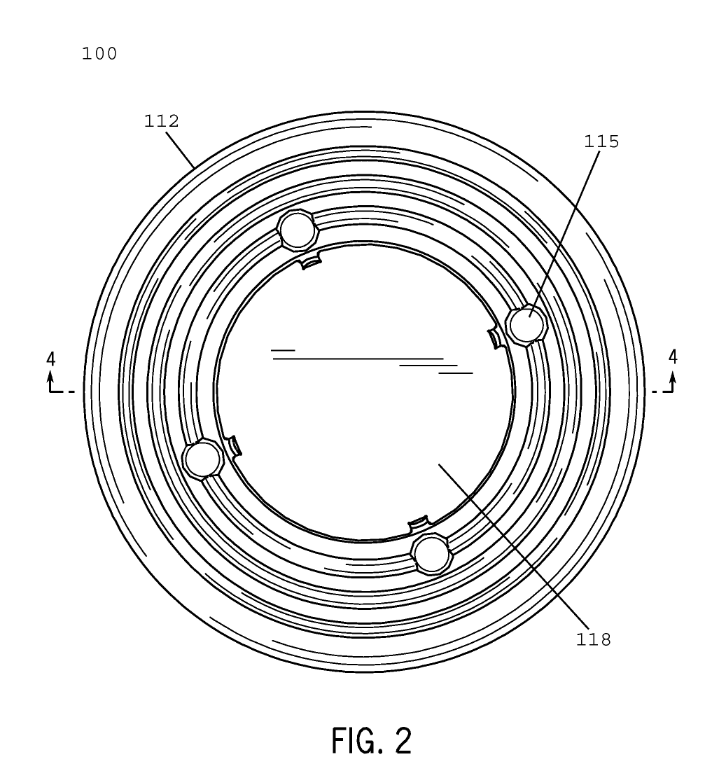

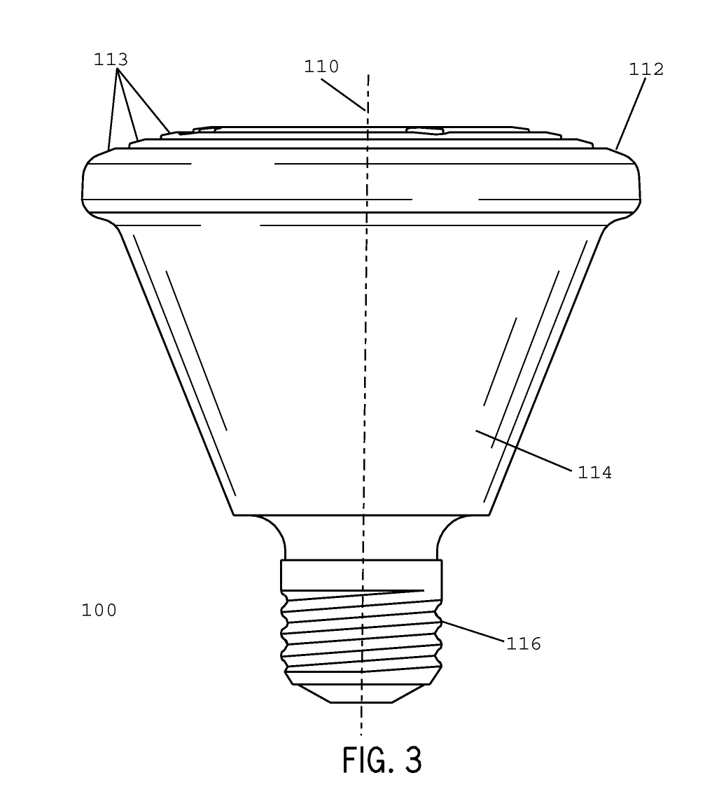

Referring to FIGS. 1-3, one embodiment of an LED lamp 100 in accordance with the invention is shown. The LED Lamp 100 has a central axis 110, front facing heat sink 112, housing 114, an electrical connector 116, and diffuser cap 118. The heat sink 112 includes a series of ribs 113 concentrically positioned with respect to the central axis 110 of the lamp 100. The front facing heat sink 112 component of the lamp 100 is thermally conductive. The housing 114 may be produced of any material, such as aluminum or steel, or could be formed of plastic due to its low cost and weight. Additionally, the housing 114 may be of any shape or size. The housing 114 may perform the function of simulating the shape and size of a traditional PAR lamp. The electrical connector 116 may be any electrical connector adapted to fit into an electrical light socket. Typical electrical connectors include an Edison screw or bayonet cap. An Edison screw type electrical connector is shown but other connectors could be readily substituted.

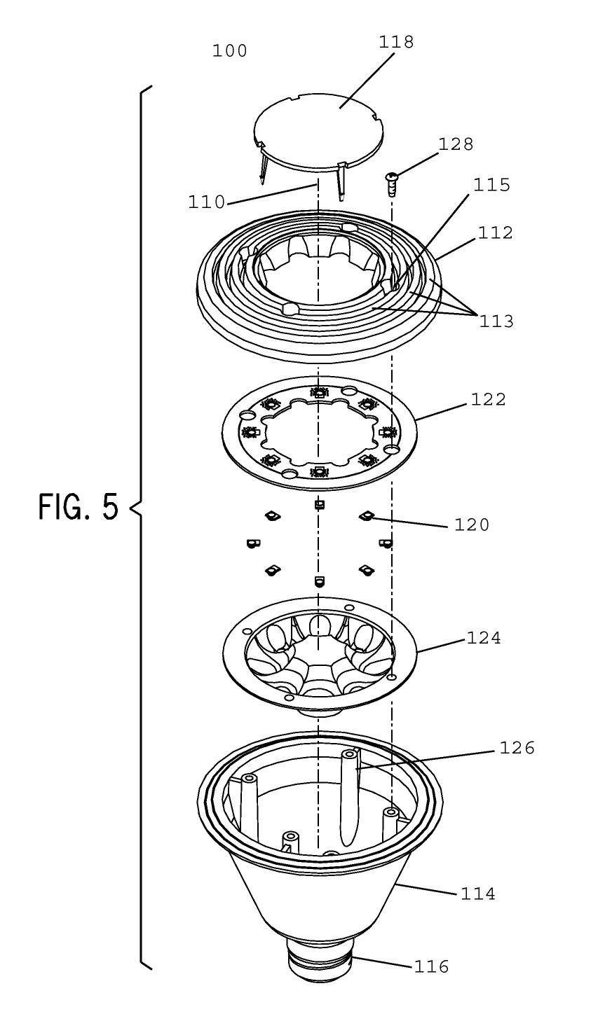

Referring now to FIGS. 5 and 5A, an exploded view showing the components of the LED lamp 100 is shown. FIG. 5 reflects the embodiment shown in FIGS. 1-4 and FIG. 5A reflects an alternative embodiment. A series of LEDs 120 arranged around the central axis 110 are attached to a printed circuit board (“PCB”) 122. The PCB 122 and LEDs 120 are attached to a reflector assembly 124 that is configured to direct the light produced by each individual LED 120 toward the central axis 110 of the lamp 100. The reflector assembly 124 may be adapted to create an endless variety of beam configurations and allows the lamp designer to very precisely control the spread of light that the lamp 100 produces. Particularly effective reflector configurations include converging optics as well as refocusing and converging optics. When these types of reflector optics are directed properly and combined, wasted light and dark spots can be minimized. As used herein “refocusing” refers to directing light rays from the natural focal point of the light source towards another focal point. For example, light from an LED is generally directed from a focal point, and a refocusing facet on the reflector reflects light rays from the LED toward a different focal point within the assembly. As used herein “converging” refers to collecting and orienting light rays in substantial alignment with each other so they generally form a beam. Converging facets in the reflector may generally collimate light rays, which means that the light rays are oriented in a generally parallel direction in a beam.

Each LED 120 has a heat pad 121 that is positioned such that it directs heat toward the front of the lamp 100. The LEDs 120, heat pads 121, PCB 122, and reflector assembly 124 are thermally coupled to the heat sink 112, typically by sandwiching the PCB 122 with LEDs 120 mounted thereon between the reflector assembly 124 and the heat sink 112. A diffuser cap 118 may be inserted into the opening in the center of the heat sink 112 to diffuse the light produced by the individual LEDs 120. Instead of the diffuser cap 118, any type of lens, clear or opaque glass, or other material, may be used. The presence of the diffuser cap 118 may also enhance the illusion that light generated by the lamp 100 comes from a single light source, rather than multiple discreet LEDs 120. Further, the diffuser cap 118 protects the internal components of the lamp 100 from inadvertent physical disturbance. In one embodiment, the heat sink 112 includes a series of attachment holes 115 that pass through the heat sink 112. FIG. 5a shows the heat sink and LED lamp assembly 138 attached to the housing through the use of heat stakes 136. Alternatively, the heat sink 112 and LED lamp assembly 138 may be ultrasonically welded to the housing 114. In another alternative embodiment shown in FIG. 5, the attachment holes 115 provide paths for screws 128 to pass through so the screws 128 may be inserted into mounting posts 126 in the housing 114. Alternative connector means could be used to secure the parts together without departing from the invention.

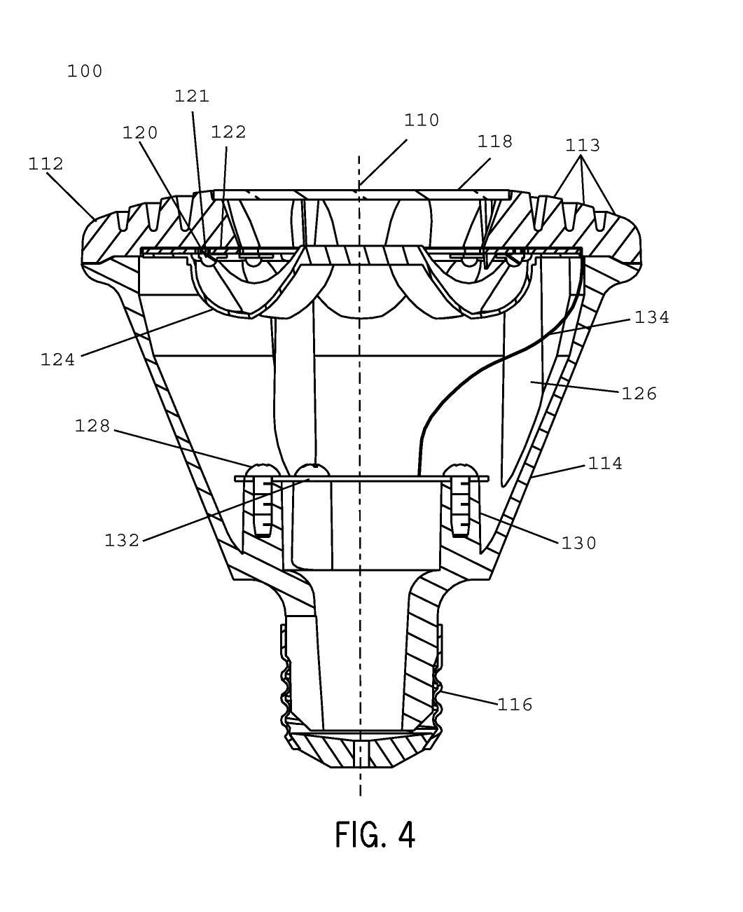

Referring now to FIG. 4, a section view of the LED lamp 100 is shown. Within the lamp housing 114, a power supply 132 (typically an alternating to direct current convertor) is attached to the housing 114 with a series of screws 128 or other suitable attachment method. The power supply 132 is electrically coupled to the PCB 122 by one or more wires 134. The power supply 132 is also electrically coupled to the electrical connector 116 and converts electrical current from a standard household electrical socket as necessary to operate the LEDs 120. The power supply 132 may also be positioned outside of the housing 114 such that it can be used to drive multiple lamps 100 simultaneously.

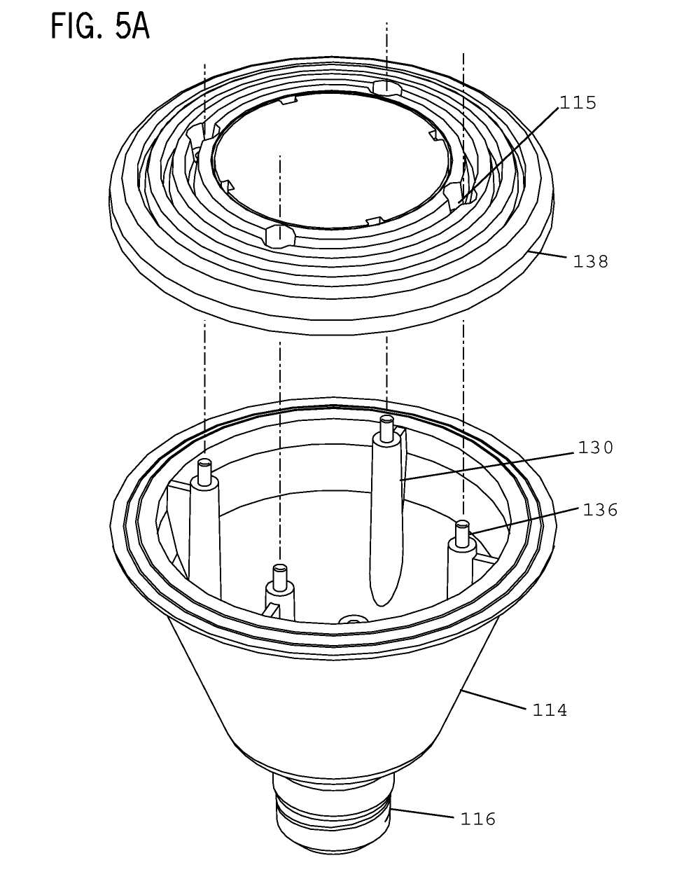

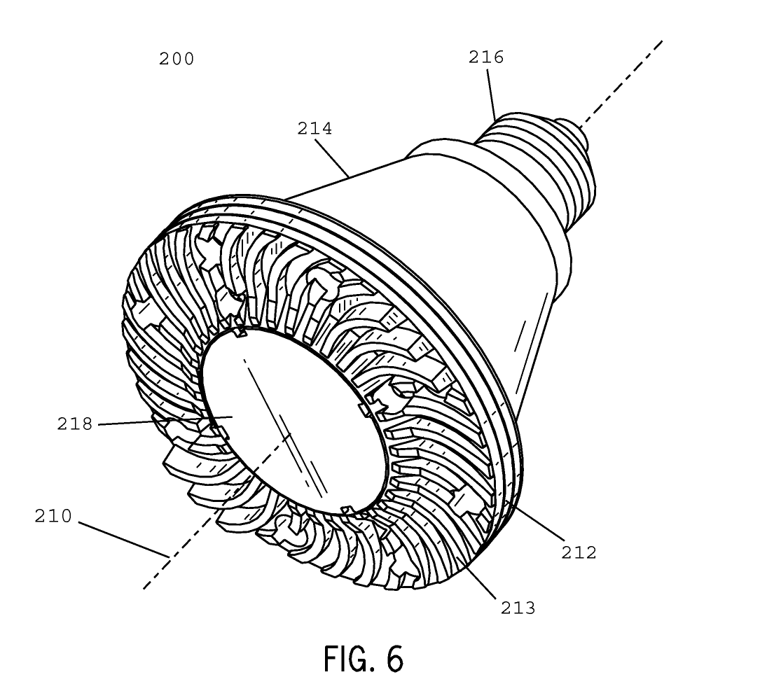

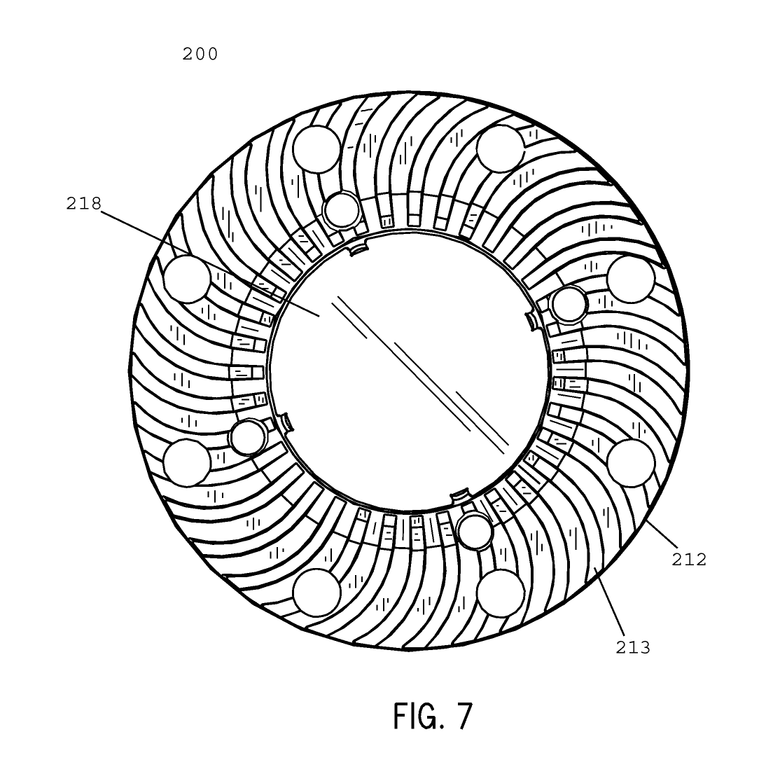

Referring to FIGS. 6-7, an alternative embodiment of an LED lamp 200 in accordance with the present invention is shown. Electrically, the LED lamp 200 is identical to LED lamp 100 described above. LED lamp 200 has a heat sink 212 that includes a series of ribs 213 that extend radially from the central axis 210 of the LED lamp 200. The ribs 213 of the heat sink 212 vary in height and profile in order to create a pleasing aesthetic appearance while also effectively dissipating the heat generated by the lamp 200. The ribs 213 in this embodiment have more heat dissipation surface area than the ribs 113 in the previously described embodiment.

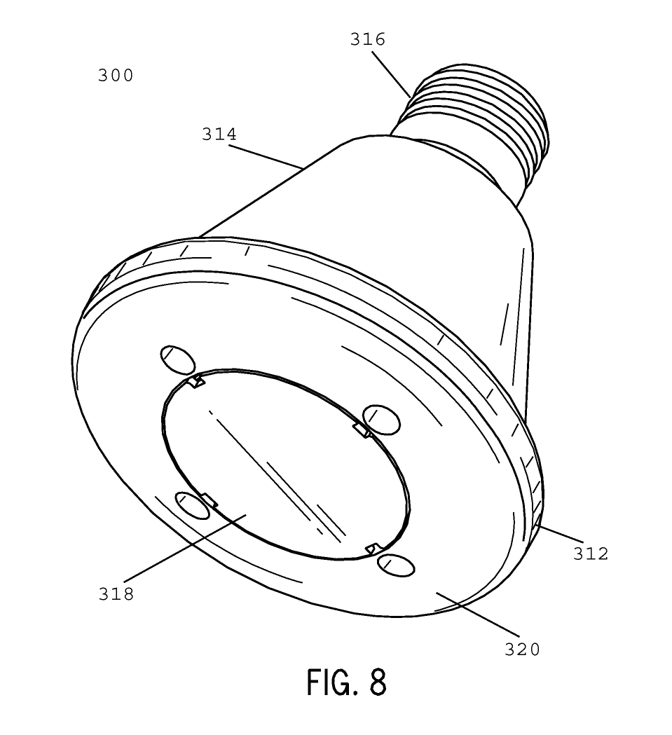

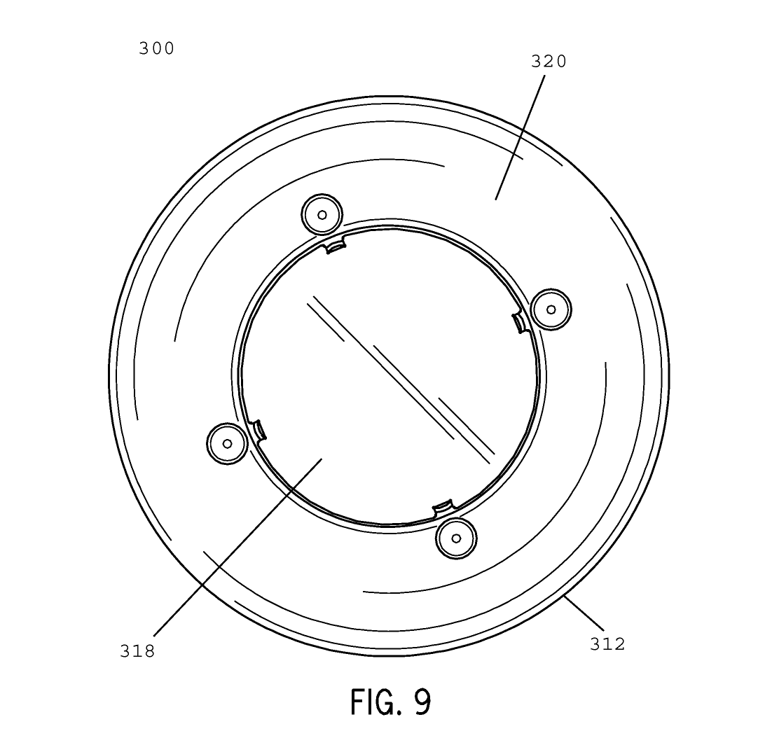

Referring to FIGS. 8-9, yet another embodiment of an LED lamp 300 in accordance with the present invention is shown. The heat sink 312 in the shown embodiment does not have any ribs. Rather, the front facing surface 320 of the heat sink 312 has a surface that mimics the profile of a traditional PAR incandescent lamp. Electronically, the LED lamp 300 is identical to LED lamp 100 described above. Many variations of the design of the heat sink 112, 212, 312 could be designed based on aesthetic performance and heat dissipation needs.

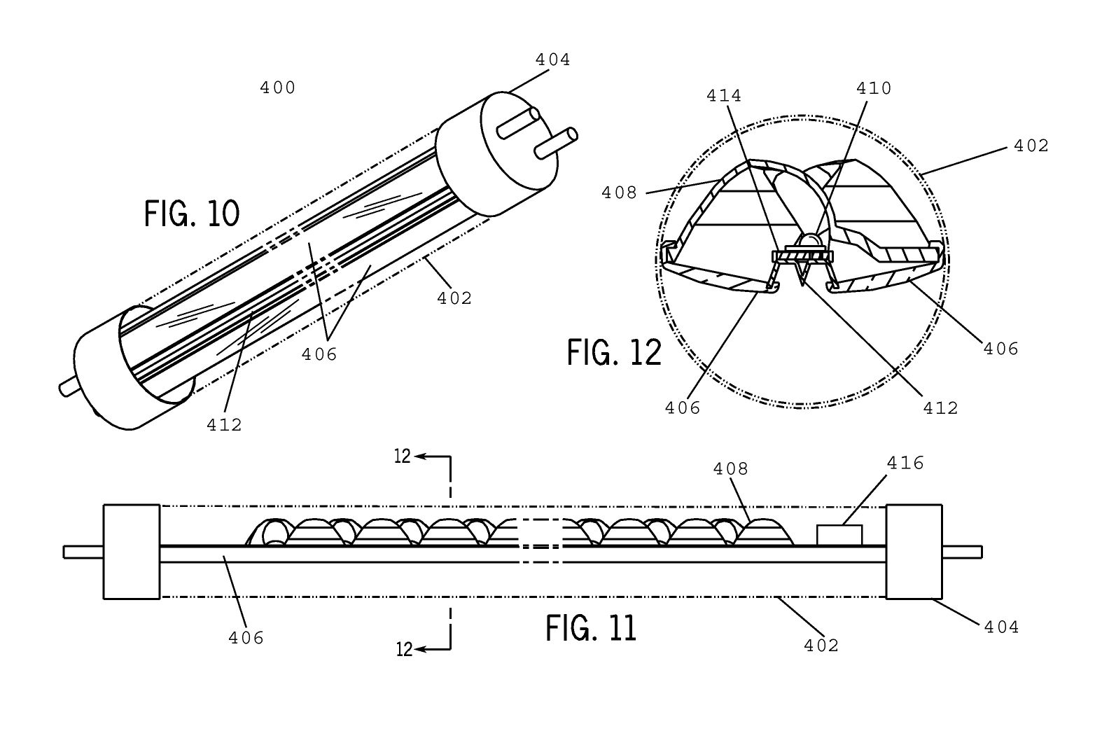

Referring now to FIGS. 10-12, another embodiment of an LED lamp 400 in accordance with the present invention is shown. The LED lamp 400 shown in FIGS. 10-12 is a replacement for a conventional fluorescent tube. The LED lamp 400 is made to fit within a fluorescent tube boundary 402, within which is a series of LEDs 410, a PCB 414, a heat sink 412, a series of reflectors 408 (or one continuous reflector), and one or more lenses 406. At each end of the tube boundary 402 is an electrical connector 404 that is adapted to fit into a standard fluorescent lamp socket. The electrical connectors 404 are electrically connected to a power supply 416, which in turn is electrically connected to the PCB 414. The power supply 416 may be located within the tube boundary 402 or may be located outside of the lamp 400. The LEDs 410 are mounted onto a PCB 414 that is thermally coupled to a heat sink 412 configured to dissipate the heat generated by the LEDs 410. The reflectors 408 are positioned to reflect the light produced by the LEDs 410 toward whatever the user desires to be lit. Of course, the reflectors 408, and lenses 406 can be designed in a multitude of ways to create any desired lighting pattern. The LEDs 410, reflectors 408, and heat sink are arranged generally longitudinally within the tube boundary 402.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

1. A lamp comprising:
a base having a central axis and having an electrical connector at an end thereof;
a plurality of reflectors positioned around the central axis of the base;
a light-emitting element associated with each reflector and positioned to emit light toward the reflector such that light is reflected by the reflector and emitted from the lamp; and
a heat sink thermally coupled to the light emitting element, the heat sink positioned with respect to the base and the reflector such that it does not interfere with the emission of light in the central axis of the lamp and such that the heat sink surface is substantially on a front of the lamp.

2. The lamp of claim 1, wherein the light-emitting element is a light-emitting diode.

3. (canceled)

4. The lamp of claim 1, wherein the heat sink is positioned concentrically around the central axis.

5. The lamp of claim 4, wherein the heat sink has concentric ribs extending therefrom.

6. The lamp of claim 4, wherein the heat sink has fins extending therefrom.

7. The lamp of claim 4, wherein the heat sink has a smooth face.

8. The lamp of claim 1 wherein the base is made of a low-thermally conductive material.

9. The lamp of claim 8 wherein the base is made of plastic.

10. A lamp comprising:
a tube boundary;
at least one reflector positioned within the tube boundary;
at least one light-emitting element associated with each reflector and positioned to emit light toward the reflector such that light is reflected by the reflector and emitted from the lamp;
a heat sink within the tube boundary thermally coupled to the light emitting element the heat sink positioned with respect to the reflector and the light-emitting element so as to direct heat emitted from the light-emitting element away from the light-emitting element and the reflector; and
at least one electrical connector attached to the light emitting element.

11. The lamp of claim 10 wherein the tube is configured to diffuse the light reflected by the reflector.

12. The lamp of claim 10 further comprising a lens positioned over the reflector so as to affect the light reflected by the reflector.

13. The lamp of claim 10 wherein the light emitting element is a light emitting diode.

14. The lamp of claim 10 wherein a plurality of light-emitting elements, reflectors, and the heat sink are positioned along the tube boundary.
